(19) United States
(12) Patent Application Publication
(10) Pub. No.: US 2013/0031241 A1
(43) Pub. Date: Jan. 31, 2013

(54) DISTRIBUTED SERVICE INSTANTIATION FOR INFORMATION-CENTRIC NETWORKS

(71) Applicants: Nico Schwan, Stuttgart (DE); Shashank Shanbhag, Stuttgart (DE); Ivica Rimac, Remseck (DE)

(72) Inventors: Nico Schwan, Stuttgart (DE); Shashank Shanbhag, Stuttgart (DE); Ivica Rimac, Remseck (DE)

(21) Appl. No.: 13/194,076

(22) Filed: Jul. 29, 2011

(51) Int. Cl. G06F 15/173

(52) U.S. Cl. 709/224; 709/238

(57) ABSTRACT

An exemplary communication device includes a node having a processor configured to instantiate a service at the node responsive to the processor determining that the node is a superior instantiation candidate relative to a next upstream node on a downstream path of the service. An exemplary method of communicating includes instantiating a service at a node responsive to the node determining that the node is a superior instantiation candidate relative to a next upstream node on a downstream path of the service.

### TECHNICAL FIELD

This invention generally relates to communication. More particularly, this invention relates to service instantiation for communication.

### DESCRIPTION OF THE RELATED ART

There have been significant changes in communications over the last several decades. The explosion of Internet and wireless communications, for example, has opened up many possibilities for a variety of types of communications. The Internet, for example, is based on a host-centric communication model, which relies upon location-dependent addresses for hosts and typically includes centralized control. Typical IP based architectures include central controllers that act as intermediaries between clients and services with global knowledge about network typology, service instances and their hosts. State information such as service load, service node and link resources are routinely updated by the central controller.

While the host-centric communication model is useful, it presents challenges when attempting to facilitate information-centric services. Such services are typically replicated on multiple servers located at different data centers and have, at best, a loose association with specific end-hosts or locations. Recent developments in communications have attempted to fit information-centric models into a host-centric communication paradigm. Proposed solutions include IP anycast, HTTP redirection and load balancing. These solutions have proven useful for centralized data centers when there are relatively low numbers of services. As the number of performance-sensitive applications increases and there are an increasing number of large-scale, geographically distributed data centers, these solutions are limited. For example, rapidly growing services may struggle with scalability and not be capable of providing ample server resources due to unpredictable popularity. A host-centric communication model may not be well-suited for handling the proliferation of information-centric services.

### SUMMARY

An exemplary communication device includes a node having a processor configured to instantiate a service at the node responsive to the processor determining that the node is a superior instantiation candidate relative to a next upstream node on a downstream path of the service.

An exemplary method of communicating includes instantiating a service at a node responsive to the node determining that the node is a superior instantiation candidate relative to a next upstream node on a downstream path of the service.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a network designed according to an embodiment of this invention.

FIG. 2 is a flowchart diagram summarizing an example approach useful within an embodiment of this invention.

FIG. 3 is a flowchart diagram summarizing an example approach useful within an embodiment of this invention.

FIG. 4 illustrates service and messaging traffic between example communication devices designed according to an embodiment of this invention.

### DETAILED DESCRIPTION

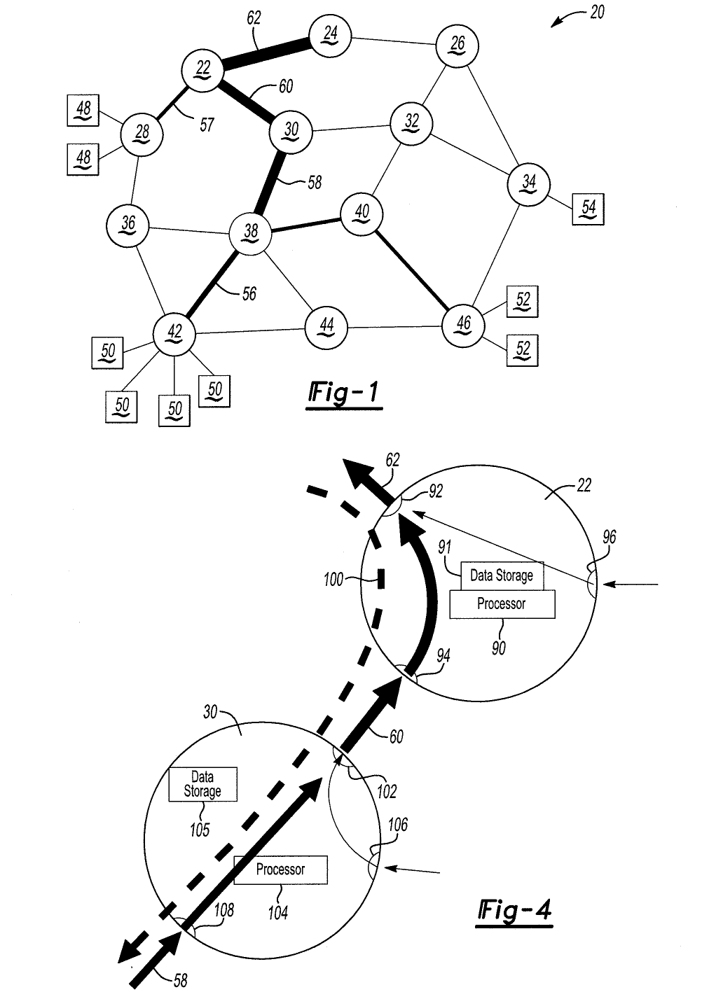

FIG. 1 schematically shows selected portions of a communication network 20. In the illustrated example, the network 20 operates on an information-centric or service-centric paradigm. For purposes of discussion, the illustrated network does not use a host-centric communication model that would involve a central controller having global knowledge regarding the network. Instead, the illustrated example uses a distributed, information-centric or service-centric architecture to address the unique challenges presented by information-centric networking (ICN).

ICN is a networking communication model that replaces machines with information. The basic principles of ICN include using an identifier of information, content or services instead of identifiers of information hosts. Routing is based on information identifiers rather than on host identifiers. Information is cached at routers in the network and re-used when possible.

The example network includes a plurality of communication devices including nodes 22, 24, 26, 28, 30, 32, 34, 36, 38, 40, 42, 44 and 46. Each of the illustrated nodes is capable of communicating with other nodes in the network and with client devices such as those schematically shown at 48, 50, 52 and 54.

In the illustrated example, the clients 48-54 are communicating using a service. In the illustration, the amount of traffic for the service is schematically represented by the thickness of the lines schematically representing the links between the nodes. For example, more clients 50 are communicating through the node 42 compared to the number of clients 48 communicating through the node 28. Therefore, the link schematically shown at 56 between the nodes 42 and 38 has a thicker line compared to the link schematically shown at 57 between the nodes 28 and 22. The node 38 processes traffic for the service originating from the clients 50 and the clients 52. Accordingly, the link 58 between the nodes 38 and 30 is schematically shown by a line that is thicker than the line associated with the link 56. Additional traffic for the service is received at the node 30 resulting in a thicker line schematically representing the link 60 between the nodes 30 and 22. In the illustrated example, all of the traffic for the service of interest is directed from the node 22 to the node 24 along the link schematically shown at 62, which has the thickest line in the illustration.

Assume for the purposes of discussion that the node 24 becomes overloaded. When any of the nodes become overloaded, it is useful or necessary to instantiate the service at another node in the network to alleviate the overloaded condition and to provide a desired quality of service level for the service of interest. The illustrated example includes nodes that are capable of instantiating a service responsive to determining that the node is a superior instantiation candidate relative to a next upstream node on a downstream path of the service. Each node is capable of instantiating a service at that node independently of any centralized controller making a decision regarding which node should instantiate the service. In other words, the illustrated example provides distributed service instantiation in which the nodes operate in a distributed architecture network. Each of the nodes is capable of determining when it should instantiate a service, independently.

The illustrated example is different than a centralized network in which a central controller or a central coordinator node has information about the entire network typology. Instead of relying on such a central controller to optimize the placement of a new service instance, the distributed approach of the illustrated example allows every node to act independently based upon a local view of the network. While each node may gather information from another node (or another device with which the node communicates) for purposes of determining whether that node should instantiate a service, each node can be considered to be independent because it does not rely upon instruction from a central controller or a central coordinator node for purposes of instantiating a service.

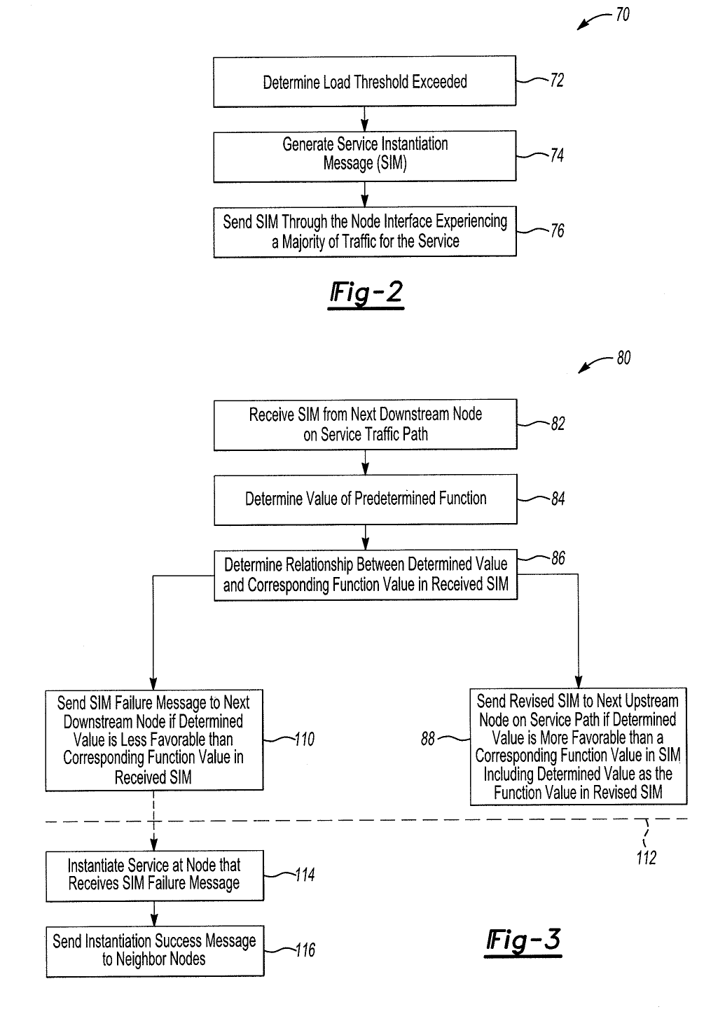

FIG. 2 includes a flowchart diagram 70 summarizing an example approach for beginning a service instantiation. At 72, the node 24 determines that a load threshold has been exceeded. At 74, the node 24 generates a service instantiation message (SIM). The SIM indicates to a node receiving the SIM that the receiving node should determine whether it should instantiate the service identified in the SIM. At 76, the node 24 sends the SIM through a node interface experiencing a majority of traffic for the service. In the example of FIG. 1, the SIM from the node 24 will be sent to the node 22 because the link 62 carries significantly more traffic for the service than any other link to the node 24.

Each of the nodes in the illustrated example has a plurality of interfaces for communicating with other nodes. Each node uses a correlation coefficient for tracking the amount of traffic for the service at each of the interfaces for the node. This allows each node to determine the path of the most traffic for the service processed by the node. In one example, each node uses Pearson's Correlation Coefficient for monitoring the relative amounts of traffic at the different interfaces for the node. The node 24 uses such an approach for determining the node to which the SIM should be directed.

For purposes of discussion, the traffic is considered to flow in a downstream direction toward the node that is experiencing the overload condition. The overloaded node (e.g., 24) sends the SIM in an upstream direction (i.e., opposite the downstream direction) along the same path followed by the majority of traffic for the service reaching that node.

FIG. 3 includes a flowchart diagram 80 that summarizes an approach by which a node instantiates a service responsive to determining that the node is a superior instantiation candidate relative to a next upstream node on the downstream path of the service. At 82, the node receives the SIM from the next downstream node on the service traffic path. The SIM prompts a node receiving the SIM to determine whether that node should instantiate that service.

At 84, the node determines a value of a predetermined evaluation function that indicates an instantiation candidate status or value for that node. Each node in the illustrated example is provided with a predetermined, objective evaluation function that takes into account selected metrics that indicate whether that node is a good candidate for instantiating the service. The evaluation function may be provided to the nodes at installation or updated occasionally by a network management entity communicating any updated functions or criteria to the nodes. In the illustrated example, all of the nodes use the same evaluation function when considering whether to instantiate a particular service.

In one example, the evaluation function incorporates information regarding a delay to the service from the node, a number of hops to the service from the node, a number of hops to the best service instance, aggregate traffic seen by the node toward the service and a correlation coefficient between the interfaces of the node where traffic for the service arrives at the node and is sent from the node, respectively. Other metrics may include quality of service indicators, load on hosted services and processing capacity at the node. The objective function is not necessarily limited to such metrics. Given this description, those skilled in the art will be able to determine how to formulate a function that will provide an appropriate indication or measure of the desirability for having a particular node instantiate the service.

In one example, when a node receives the SIM, the first step involves determining whether the node has appropriate processing capacity to be able to instantiate a service. If not, the node does not determine a value of the evaluation function, but instead forwards the SIM to a next upstream node on the downstream traffic path. In one example, each node has a range or threshold within which the available processing capability should fit as a prerequisite to the node determining a value of the evaluation function. This avoids a situation in which a node instantiates a service and then very quickly becomes overloaded requiring another instantiation.

For purposes of determining some metrics, the illustrated example includes using “ant colony” optimization techniques for gathering information regarding other portions of the network. Given that there is no centralized controller making decisions regarding which node should instantiate a service, each node utilizes as much information as the individual node can determine given that the node does not have knowledge of the entire network typology.

At 86, the node determines a relationship between the value of the evaluation function for that node and a corresponding function value in the received SIM. The overloaded node that initiates the SIM includes a value within the SIM that ensures that the determined value by the next upstream node will be more favorable compared to the value included in the SIM. In one example, the originating node of the SIM leaves the field blank where the corresponding function value would be included in the SIM. In another example, the node that originates the SIM includes a zero value. In still another example, the originating node includes a value that is configured to ensure that the next upstream node will determine a value that is more favorable.

Based upon the determination at 86, the node will either instantiate the service or send a revised SIM to the next upstream node on the downstream path of the service traffic.

Assuming that the node that has performed the steps 82, 84 and 86 in FIG. 3 determines that the value of the predetermined function for that node is more favorable than the corresponding function value in the received SIM, the node performs the step shown at 88. The node will send a revised SIM to the next upstream node on the service path. The revised SIM includes the determined value of the evaluation function from that node so that the next node will compare its own value with the corresponding value of the node from which the SIM was received. Comparing the values in this manner provides an indication of the relative status of the two nodes corresponding to which of them is a superior instantiation candidate.

Whether a node is a superior instantiation candidate relative to another node depends on the evaluation function. For example, one evaluation function may provide a result that a third node is superior to a fourth node along an upstream path of a service while another evaluation function will indicate that the fourth node is superior to the third node under the same conditions. The particular criteria included in an evaluation function and the manner in which the results of the evaluation function are treated will determine superiority in a particular embodiment. Further, it is possible to configure an evaluation function to indicate that a node is a superior instantiation candidate compared to another node even though the former has at least one characteristic that is less favorable than the corresponding characteristic of the latter. Those skilled in the art who have the benefit of this description will be able to design or select an evaluation function that will meet the needs of their particular situation.

FIG. 4 schematically shows two example nodes involved in the process of instantiating a service. For discussion purposes, the nodes 22 and 30 are illustrated. The node 22 includes a processor 90 that makes the determination whether the node 22 should instantiate the service of interest. Digital data storage 91 is associated with the processor 90. In one example, the processor includes its own digital data storage. In another example, the node 90 is communicatively coupled to digital data storage.

The processor (utilizing or in cooperation with the digital data storage 91) monitors the traffic at each of a plurality of interfaces 92, 94 and 96 for that node. According to the illustration, most of the service traffic for the service of interest is received at the node 22 through the interface 94 and most of it is forwarded from the node 22 through the interface 92. Some service traffic is received through the interface 96, although that is a smaller percentage of the total service traffic processed by the node 22.

Given that most of the service traffic passes through the interfaces 94 and 92, the SIM will be received by the node 22 through the interface 92. The processor 90 determines to send a revised SIM (assuming that the node 22 is performing the step 88 from FIG. 3, for example) through the interface 94 because that is the one associated with the majority of traffic for that service arriving at the node 22 in the downstream direction. The processor 90 directs the revised SIM to be sent through the node 94 in an upstream direction. The communication of the SIM and the revised SIMs is schematically shown at 100. Again, the “downstream” direction for purposes of discussion is the direction of service traffic flow toward the node that is experiencing an overload condition. The “upstream” direction is the opposite direction to the downstream direction, which would be away from the overloaded node in this example.

The processor 90 (utilizing or in cooperation with the digital data storage 91) is configured to perform the steps shown in FIG. 2 in the event that the node 22 becomes overloaded. The processor 90 (utilizing or in cooperation with the digital data storage 91) is also configured to perform the steps shown in FIG. 3 for purposes of instantiating a service at the node 22 if that node is the best node according to predetermined criteria. In this example, the node 22 receives the SIM from the node 24, which originates the SIM. The value of the evaluation function that the processor 90 determines will necessarily be superior to or more favorable than the corresponding value within the SIM from the node 24, which originated the SIM, for the reasons discussed above. The processor 90 determines to send a revised SIM including an indication of the value determined by the processor 90 and to send that to the node 30 through the interface 94.

The node 30 receives the revised SIM through an interface 102. A processor 104 of the node 30, which has an associated digital data storage 105, recognizes the revised SIM from the node 22 as an indicator to attempt to instantiate the service identified in the SIM. This triggers the processor 104 determining its own value of the evaluation function as shown at 84 in FIG. 3, for example. The processor 104 determines whether its own determined value is more favorable than the corresponding function value in the SIM received at the node 30. For purposes of discussion, the value determined by the processor 104 is more favorable than the value contained in the SIM received by the node 30 (e.g., the corresponding value of the node 22, which is the next downstream node). Accordingly, the processor 104 will send a revised SIM to the next upstream node on the service path (which would be node 38 according to FIG. 1) including the corresponding function value determined by the processor 104. The processor 104 considers whether to send the revised SIM through the interface 106 or 108 based upon an amount of service traffic received through each interface. In the illustrated example, the interface 108 experiences more of the service traffic and, therefore, the revised SIM is directed as schematically shown at 100 through the interface 108 toward the next upstream node on the service traffic path.

At some point along the traffic path, one of the next upstream nodes will have a value for the evaluation function that is less favorable than the corresponding value in the SIM received by that node. At that point in the example of FIG. 3 that node sends a SIM failure message to the next downstream node (i.e., the node from which the SIM was received by that node) as shown at 110. The SIM failure message is received by the appropriate node and that provides an indication to that next downstream node that it is a superior candidate for instantiating the service relative to the next upstream node on the service traffic path.

In FIG. 3 the broken line 112 divides the illustrated flowchart between functions performed by one node above the line and functions performed by the next downstream node below the line 112. At 114, the next downstream node responds to the SIM failure message from the next upstream node by instantiating the service at that node. The determination to instantiate the service and the process of instantiating occurs in a distributed manner (e.g., at each node independently) and independent of a central controller. Upon successfully instantiating the service, that node sends an instantiation success message to neighbor nodes at 116.

The illustrated example allows for a decentralized, distributed approach at finding the best node (according to determined criteria incorporated into the predetermined evaluation function) at which to instantiate a service without requiring any central controller. Moreover, the decision where to instantiate the service is service-centric or information-centric. The SIM includes an identifier of the service of interest and the metrics used for the evaluation function are relative to the service of interest. The instantiating node does not need global information regarding other portions of the network for purposes of deciding whether it is the superior candidate compared to another node for instantiating the service. Depending on how the evaluation function is arranged and the decision metrics that are selected, a different result may occur in different circumstances. For example, if it is desirable to instantiate a service at a node experiencing the greatest amount of service traffic, the evaluation function can be weighted to provide more favorable values based upon the amount of traffic at a node. In another example, delay is an important metric and the evaluation function is weighted so that the node that tends to be closest to the clients will have a more favorable value and be more likely to instantiate the service. Given this description, those skilled in the art will realize what metrics to consider and how to weight each of them to achieve results that satisfy their particular needs.

The example embodiments include, for example, programming and logic stored within the digital data storage and the memory is part of or communicatively connected to the processor. In other examples, such information may be stored in another suitable manner (e.g., using any suitable number of memories, storages or databases; using any suitable arrangement of memories, storages or databases communicatively coupled to any suitable arrangement of devices; storing information in any suitable combination of memory(s), storage(s), internal database(s), external database(s) or a combination of these; or using any suitable number of accessible external memories, storages or databases). As such, the term “digital data storage” as used in this description is meant to encompass all suitable combinations of memory(s), storage(s), and database(s).

The functions of the various elements shown in the illustrations, including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, an application specific integrated circuit (ASIC), a field programmable gate array (FPGA), read only memory (ROM) for storing software, random access memory (RAM), and non volatile storage. Other hardware, whether conventional custom or a combination of them, also may be included.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A communication device, comprising
a node including a processor configured to instantiate a service at the node responsive to the processor determining that the node is a superior instantiation candidate relative to a next upstream node on a downstream path of the service.

2. The communication device of claim 1, wherein the processor instantiates the service at the node responsive to receiving a message from the next node that indicates that the node is a superior instantiation candidate relative to the next node.

3. The communication device of claim 1, wherein the node sends a service instantiation success message to any neighbor nodes if the node instantiates the service.

4. The device of claim 1, wherein the processor is configured to:
determine when a service instantiation message (SIM) is received by the node from a first other node;
determine a value of a predetermined function that is indicative of whether the node should instantiate the service indicated by the SIM;
determine a relationship between the determined value and a corresponding function value indicated in the SIM; and
send a message to the first other node responsive to determining that the determined value is less favorable than the function value indicated in the SIM or send a revised version of the SIM to a second other node including the determined value as the function value indicated in the revised version of the SIM.

5. The communication device of claim 4, wherein the predetermined function is based at least partially on at least one of
(i) an amount of traffic for the service at the node,
(ii) a distance between the node and a source of the service and
(iii) a delay between the node and a source of the service.

6. The communication device of claim 5, wherein the amount of traffic comprises a relationship between an amount of traffic for the service at each of a plurality of interfaces of the node.

7. The communication device of claim 4, wherein the node selects an interface of the node through which to send the revised version of the SIM based on an amount of traffic for the service passing through each of a plurality of interfaces of the node.

8. The communication device of claim 4, wherein the processor is configured to instantiate the service at the node responsive to a message from the second other node, the message serving as an indication that the function value of the second other node is less favorable than the function value of the node.

9. The communication device of claim 1, wherein the node sends a message to a next downstream node on the downstream path of the service responsive to the processor determining that the next downstream node is a superior instantiation candidate relative to the node, the message serving as an indication that the next downstream node should instantiate the service.

10. The communication device of claim 1, wherein the processor is configured to
generate a service instantiation message (SIM) for an overloaded service processed by the node responsive to a load threshold being exceeded at the node; and
cause the node to send the generated SIM message to a neighbor node of the node through an interface of the node through which a largest amount of traffic for the overloaded service passes.

11. A method of communicating, comprising
instantiating a service at a node responsive to the node determining that the node is a superior instantiation candidate relative to a next upstream node on a downstream path of the service.

12. The method of claim 11, comprising instantiating the service at the node responsive to receiving a message from the next node that indicates that the node is a superior instantiation candidate relative to the next node.

13. The method of claim 11, comprising sending a service instantiation success message to any neighbor nodes if the node instantiates the service.

14. The method of claim 11, comprising the steps of:
receiving a service instantiation message (SIM) at the node from a first other node;
determining a value of a predetermined function that is indicative of whether the node should instantiate the service indicated by the SIM;
determining a relationship between the determined value and a corresponding function value indicated in the SIM; and
sending a message to the first other node responsive to determining that the determined value is less favorable than the function value indicated in the SIM or sending a revised version of the SIM to a second other node including the determined value as the function value indicated in the revised version of the SIM.

15. The method of claim 14, comprising instantiating the service at the node responsive to receiving a message from the second other node, the message serving as an indication that the function value of the second other node is less favorable than the function value of the node.

16. The method of claim 14, wherein the predetermined function is based at least partially on at least one of
(i) an amount of traffic for the service at the node,
(ii) a distance between the node and a source of the service and
(iii) a delay between the node and a source of the service.

17. The method of claim 16, wherein the amount of traffic comprises a relationship between an amount of traffic for the service at each of a plurality of interfaces of the node.

18. The method of claim 14, comprising selecting an interface of the node through which to send the revised version of the SIM based on an amount of traffic for the service passing through each of a plurality of interfaces of the node.

19. The method of claim 11, comprising sending a message to a next downstream node on the downstream path of the service responsive to determining that the next downstream node is a superior instantiation candidate relative to the node, the message serving as an indication that the next downstream node should instantiate the service.

20. The method of claim 11, comprising
generating a SIM message for an overloaded service processed by the node responsive to a load threshold being exceeded at the node; and
sending the generated SIM message to a neighbor node of the node through an interface of the node through which a largest amount of traffic for the overloaded service passes.
